(19) United States
(12) Patent Application Publication
(10) Pub. No.: US 2013/0069358 A1
(43) Pub. Date: Mar. 21, 2013

(54) Secured Document and Manufacturing Method of Said Secured Document

(71) Applicant: Hologram. Industries, Bussy Saint Georges (FR)

(72) Inventors: Philippe Huet, Sainte Genevieve Des Bois (FR); Antoine Dhome, Bussy Saint Georges (FR); Christophe Duriez, Bry Sur Marne (FR); Delphine Tavernier-Lohr, Vincennes (FR)

(73) Assignee: HOLOGRAM.INDUSTRIES, Bussy Saint Georges (FR)

(21) Appl. No.: 13/622,710

(22) Filed: Sep. 19, 2012

(30) Foreign Application Priority Data
Sep. 21, 2011 (FR) 1158385

(51) Int. Cl. B42D 15/00

(52) U.S. Cl. 283/67; 283/72

(57) ABSTRACT

The present invention relates to a method of securement of a security document comprising providing a security document to be secured comprising a support on which are inscribed personalization data, an optical security component covering at least a portion of the personalization data and an adhesive layer positioned between the support and the optical security component, and applying a transparent anti-adhesive layer on the optical security component.

### FIELD OF THE INVENTION

The invention relates to security documents and their manufacturing methods, and relates in particular to security documents comprising an optical security component.

### DESCRIPTION OF THE PRIOR ART

Generally, security documents, such as official identity documents, are made in two stages: first personalization data, such as the holder's personal data, are printed on the security document support, generally comprising paper, and these data are protected and secured by simultaneous transfer of various protective layers. The combination of the protective layers and the security document support is performed, according to the prior art, by thermal lamination or hot pressing of the security document so as to thermobind the protective layers on the security document support through, for example, a heat-reactivable adhesive.

The personalization data can include information to be read, or readable information, which usually appear as a photo and text in a visual inspection zone and in a zone readable by a machine.

To guard against counterfeiting or falsification of security documents and to increase the security level of these documents, it is known to incorporate therein particular security elements.

In said security documents, the security elements commonly used are optical security elements. These optical security elements are generally optically variable elements, such as diffractive structures including holograms. These optically variable elements are generally in the form of laminates which comprise a reflecting layer, at least partially transparent, and a layer comprising a diffractive microstructure and which are arranged so as to cover the variable data contained in security documents in order to protect these documents, particularly against the falsification of their data. These laminates have a dual function, one of authentication of the security document and one of protection of the security document against falsification. The optical security elements must be complex enough to prevent a counterfeiter from replicating or simulating the optical security element. The thickness of the layers transferred on the laminate is less than 10 microns (preferably less than 5 microns) which does not any confer rigidity to the assembly, which is therefore not handleable.

Attempts of falsification, counterfeiting, or violation of security documents protected by a laminate consist mostly in sticking an adhesive film on the laminate and then peeling the entire film/laminate from the security document following the dissolution with a solvent or the reactivation by heating of the adhesive, which keeps the laminate stuck on the document. The falsifier has then the possibility to peel the laminate from the security document without damaging either the security document, or the personalization data that it holds, or, above all, the laminate. The falsifier can then, for example, falsify the personalization data of the security document and then stick back the laminate over it or stick the laminate on another security document.

It is known, to prevent this falsification attack, to incorporate into the security documents reagents intended to cause a coloured reaction in the event of attack of the security document with solvents, among others non-polar solvents.

WO-A-00/71361 discloses a process of protecting an object in which a thin protective film of synthetic material is stuck on one side of the object with an adhesive layer inserted between said side and the object, characterized in that at least one printing is inserted between the film and said side of the object, the at least one printing being made with an ink composition comprising at least a pigment and a binder hardenable by drying in air, adapted to form a solid printing layer after drying, and incorporating at least one agent, known as a soluble agent, adapted to dissolve in any polar and/or non-polar liquid solvent suitable for enabling the peeling of the adhesive when it is placed in contact with this adhesive after sticking, the quantity of soluble agent in the binder being adapted so that the security printing can form at least one visible spot revealing any attempt at unsticking with at least one such solvent.

EP-A-1349987 discloses a security paper comprising at least one zone reacting with non-polar solvents, this security paper being characterized in that it comprises a barrier impermeable to non-polar solvents between a first outer side of the security paper and the zone reacting with non-polar solvents.

However, the securement of security documents according to the prior art is expensive and has the disadvantage that it must be chosen and implemented from the design of the security documents.

### SUMMARY OF THE INVENTION

An object of the present invention is that of providing security documents of the type comprising a support on which are inscribed personalization data, a security optical component covering at least a portion of the personalization data and an adhesive layer positioned between the support and the optical security component, allowing to improve the securement of the security documents by increasing the resistance to falsification. In this perspective, the applicant has advantageously found that the addition of a transparent anti-adhesive layer, positioned on the optical security component, fulfils this object.

In the present description and in the claims that follow, the terms “security document” are used in reference to any official identity document, such as, for example, a passport, an identity card, a driving license, a diploma or to any document, packaging or product bearing personalization data that are susceptible to be counterfeited and requiring a guarantee of authenticity and/or completeness.

In the present description and in the claims that follow, the terms “personalization data” are used in reference to information contained in the security document to be read with a naked eye or by a machine in order to identify and/or authenticate the security document. These personalization data can be data appearing in the form of photo, text containing for example the biographical data of the holder of the security document, data appearing in the form of symbols or numbers or in any other form permitting to identify and/or authenticate the security document.

In the present description and in the claims that follow, the term “surface”, when used in reference to the security document according to the invention, refers to the surface of the security document opposite to the support of the security document.

In the present description and in the claims that follow, the term “reflective” is used in reference to the reflection of light at least partially in the visible range. Thus, for example, a reflecting layer is a layer which can reflect light at least partially in the visible range.

In the present description and in the claims that follow, the term “transparent” is used in reference to the passage at least partial of light in the visible range through a medium. Thus, for example, a reflecting layer is a layer capable of at least partially letting light, in the visible range, go through.

According to a first aspect of the present invention, said object is achieved by a security document comprising a support on which are inscribed personalization data, an optical security component covering at least a portion of the personalization data, an adhesive layer positioned between the support and the optical security component and a transparent anti-adhesive layer, positioned on the optical security component.

The fact of adding a transparent anti-adhesive layer on the optical security component of the security document allows to make non-adhesive the surface of the security document and thus to prevent the peeling of the optical security component by using an adhesive film.

Advantageously, the security document presents a reinforced resistance to mechanical and chemical attacks. In addition, the porosity of the surface of the security document is decreased, which reduces the risks of penetration of foreign bodies due to the normal handling of the security document which could produce marks and/or local physicochemical degradations.

Advantageously, the surface of the security document becomes not printable. The falsifier cannot therefore attempt a falsification by surface printing.

According to a preferred embodiment, the anti-adhesive layer covers more than 90% of the surface of the security document. In another preferred embodiment, the anti-adhesive layer forms a first predetermined pattern.

Advantageously, the anti-adhesive layer having a first predetermined pattern allows to vary the surface characteristics, such as the total surface energy and the peeling tension, on the surface of the security document. Therefore, all falsification attempts with an adhesive film will lead to the appearance of a pattern corresponding to the first predetermined pattern and corresponding to the areas having more or less adhesion, i.e., having a character of wettability more or less great, with the adhesive film of the falsifier.

Advantageously, the first predetermined pattern is selected so that the peeling forces are inhomogeneous on the surface of the security document. The falsification of the security document is even more difficult because there is no preferred direction to peel the adhesive film and the optical security component for falsification purpose.

The constitutive elements of the first predetermined pattern can be for example screens, micro-lines, guilloches, significant elements, such as a logo or a slogan, that can be filled or drawn only by their (wired) contour. In a preferred embodiment, the first predetermined pattern comprises fixed or variable constitutive elements. In a preferred embodiment, the variable constitutive elements are specific either to the security document, or to the holder, or to the series of security documents.

According to a preferred embodiment, the first predetermined pattern is such that it allows to counteract the curvature of the security document after the lamination of the optical security component. Indeed, the lamination of the optical security component on the support of the security document usually causes the curvature of the security document. According to a preferred embodiment, the first predetermined pattern comprises constitutive elements perpendicular to the curvature of the security document.

According to an embodiment, the security document presents a surface having a reduced total surface energy relative to the surface energy of a security document according to the prior art. In other words, the security document presents a surface having a reduced wettability compared to the wettability of the surface of a security document according to the prior art.

Wetting describes the physical phenomena when three phases, of which at least one is liquid, are put into contact. As shown in FIGS. 1a and 1b, when liquid 103 is deposited on a solid surface 102, in a gas 101, either it spreads completely (FIG. 1a) or it forms a drop with a contact angle θ with the solid (FIG. 1b). The bigger the angle θ is, the greater the wettability of the solid is reduced.

In FIGS. 1a and 1b, γ_{S}, is the interfacial tension between the solid 102 and the gas 101, γ_{SL} is the interfacial tension between the solid 102 and the liquid 103 and γ_{L} is the interfacial tension between the liquid 103 and the gas 101.

The surface energy can be measured by any suitable technique known by the man skilled in the art, and for example by measurement acquired with a GBX Scientific Instrumentation device, which provides measurements according to the approach of Owens-Wendt. This approach corresponds to the following equation:

cos θ=−1+2\sqrt{γ_{S}^{d}}(\sqrt{γ_{L}^{d}}/γ_{L})+2\sqrt{γ_{S}^{nd}}(\sqrt{γ_{L}^{nd}}/γ_{L})

wherein θ is the contact angle of the drop on the surface, γ_{S}^{d} and γ_{S}^{nd} are, respectively, the dispersive component and the non-dispersive component of the interfacial tension between the solid 102 and the gas 101, γ_{L}^{d} and γ_{L}^{nd}, are, respectively, the dispersive component and the non-dispersive component of the interfacial tension between the liquid 103 and the gas 101, and γ_{L} is the interfacial tension between the liquid 103 and the gas 101.

In a preferred embodiment, the anti-adhesive layer has an average total surface energy of less than 25 mN/m, and preferably less than 20 mN/m.

According to an embodiment, the security document presents a surface having reduced peeling characteristics compared to the peeling characteristics of the surface of a security document according to the prior art. In other words, the surface of the security document according to the invention has a reduced average peeling force compared to the average peeling force of the surface of a security document according to the prior art.

The peeling force can be measured by any suitable technique known by the man skilled in the art, for example, by a measurement, shown in FIG. 2, according to an adaptation of the FINAT FTM 1 standard in which the peeling force is the force required to remove a strip of standard test adhesive material 104, which was applied to the sample 105, of the sample at an angle of 90° and at a speed of 1000 mm per minute (as shown by the arrow in FIG. 2). To perform this measurement, the standard test adhesive material is a 3M adhesive tape referenced as 3M-VHB, and is pasted to a polyester sheet having a thickness of 36 microns, the band of adhesive material has a width of 20 mm and the sample security document has a width of 85 mm.

In a preferred embodiment, the anti-adhesive layer has an average peeling force of less than 1 N, and preferably of less than 500 mN.

In a preferred embodiment, the anti-adhesive layer has an average thickness of less than 5 microns, and preferably between 1 and 2 microns.

In an embodiment, the anti-adhesive layer comprises at least a cross-linkable resin, a cross-linking initiator agent and a slip agent.

In a preferred embodiment, the crosslinkable resin comprises at least one of a polyester resin, an epoxy resin, a polyether resin, a polyol resin, a polyurethane resin or an acrylic resin. In a preferred embodiment, the crosslinkable resin is cross-linkable by UVs.

The crosslinking initiator agent is capable of initiating a crosslinking reaction of the crosslinkable resin. In a preferred embodiment, the crosslinking initiator agent is a photoinitiator or thermoinitiator agent. In a preferred embodiment, the photoinitiator agent is a radical or ionic agent. In a preferred embodiment, the photoinitiator is selected from benzophenone derivatives, ketones, phosphorus derivatives, and sulphur derivatives.

In a preferred embodiment, the slip agent comprises at least one of a reactive silicone or a wax.

In a preferred embodiment, the anti-adhesive layer further comprises a mono- or poly-functional, crosslinkable solvent. In a preferred embodiment, the solvent is crosslinkable by UVs.

According to a preferred embodiment, the anti-adhesive layer is crosslinked. Advantageously, this crosslinking prevents the subsequent dissolution of the anti-adhesive layer for malicious purposes by counterfeiters.

In a preferred embodiment, the anti-adhesive layer further comprises a physico-chemical marker that is not visible to the naked eye but can be revealed by the use of a suitable tool, such as a spectrometer, or by a specific light. Advantageously, the addition of a physicochemical marker allows strengthening the securement of the security document

According to an embodiment, the anti-adhesive layer comprises a material such that the surface of the security document diffuses, at least partially, light. According to a preferred embodiment, the anti-adhesive layer comprises a material such that the surface of the security document is at least partially matt. Advantageously, such an anti-adhesive layer can provide the security document according to the invention with a distinctive mark on the surface of the security document, thereby strengthening its securement.

The support comprises any suitable material known by the man skilled in the art. In a preferred embodiment, the support comprises at least one of natural paper, synthetic paper, and plastic material. In a preferred embodiment, the support is a multi-layered support, each layer comprising at least one of natural paper, synthetic paper, and plastic material. Preferably, the plastic material comprises at least one of polycarbonate, polyethylene, polyvinyl chloride, ABS (acrylonitrile butadiene styrene), polystyrene, PEC, polyethylene terephthalate or any combination of these materials.

In a preferred embodiment, the support has an average thickness comprised between 50 and 500 microns, and preferably between 80 and 120 microns.

The optical security component may comprise any suitable optical security element known by the man skilled in the art. In a preferred embodiment, the optical security component comprises at least one optically variable element, preferably at least one diffractive structure. In a preferred embodiment, the optical security component comprises at least one hologram.

According to a preferred embodiment, the optical security component covers at least a portion of the personalization data, and preferably all of the personalization data.

According to a preferred embodiment, the optical security component covers all of the support. In another preferred embodiment, the optical security component forms a second predetermined pattern covering at least a portion of the personalization data.

According to a preferred embodiment, the optical component has an average thickness comprised between 2 and 100 microns, and preferably between 4 and 40 microns.

In a preferred embodiment, the second predetermined pattern is continuous. In another preferred embodiment, the second predetermined pattern is discontinuous.

In a preferred embodiment, the optical security component comprises one transparent reflecting layer, positioned on the adhesive layer of the security document and a layer comprising at least one security optical element and positioned on the reflecting layer.

In a preferred embodiment, the reflecting layer has an average thickness comprised between 5 and 500 nm, preferably between 5 and 250 nm and preferably between 10 and 100 nm.

According to a preferred embodiment, the reflecting layer comprises at least a component having a high refractive index, for example greater than 2. In a preferred embodiment, the reflecting layer comprises at least one component selected from zinc sulphide, titanium dioxide or zirconium oxide.

In a preferred embodiment, the layer comprising at least one optical security element has an average thickness of less than or equal to 10 microns, and preferably comprised between 2 and 10 microns.

According to a preferred embodiment, the layer comprising at least one optical security element comprises a thermoformable varnish. In another preferred embodiment, the layer comprising at least one optical security element comprises at least one acrylic varnish.

In a preferred embodiment, the optical security element is a diffusing structure or a diffracting structure or a combination of different structure types.

In another preferred embodiment, the optical security component may further comprise at least one protective layer positioned on the layer comprising at least one optical security element.

The protective layer allows protecting the security document against at least one of dirt, scratches, chemical attacks. In a preferred embodiment, the protective layer comprises a polymer varnish. In a preferred embodiment, the protective layer has a thickness comprised between 0.1 and 1.5 microns, preferably between 0.2 and 0.5 microns.

The adhesive layer allows to weld the support and the optical security component together and comprises any suitable material known by the man skilled in the art. In a preferred embodiment, the adhesive layer comprises at least one heat-activable adhesive.

In a preferred embodiment, the adhesive layer comprises polymers having a melting point of between 40° C. and 200° C., preferably an acrylic copolymer-based adhesive in an aqueous dispersion or a solvent. In a preferred embodiment, the adhesive layer comprises at least one of an acrylic resin, a polyvinyl acetate, a vinyl thermoplastic resin, an adhesive comprising a copolymer in an aqueous dispersion or a solvent, an epoxy, a polyester, or a combination of these materials or materials with similar characteristics.

In a preferred embodiment, the adhesive layer has an average thickness comprised between 2 and 25 microns, preferably between 4 and 10 microns.

In a preferred embodiment, the adhesive layer comprises heat-reactivable adhesives requiring a post-crosslinking.

Another aspect of the present invention relates to a method of securement a security document comprising providing a security document to be secured comprising a support on which are inscribed personalization data, an optical security component covering at least a portion of the personalization data and an adhesive layer positioned between the support and the optical security component, and applying a transparent anti-adhesive layer on the optical security component.

In the prior art, the method for producing a security document comprises preparing an optical security component in the form of a laminate on a separable film, inscribing the personalization data on the support of the security document, lamining the optical security component on the support of the security document, and then removing the separable film so as to transfer only the laminate on the security document. The preparation of optical security component comprises, in general, applying an embossable layer on the separable film, embossing the embossable layer in order to integrate therein an optical security element, applying a transparent reflecting layer on the embossed layer, and then applying an adhesive layer on the reflecting layer.

Thus, according to the prior art, the lamination of the optical security component is the final step of the preparation of a security document. An anti-adhesive layer cannot be introduced into the structure of the optical security component because it would provoke inopportune detachments during the embossing process of the optical security component.

Advantageously, the method according to the invention allows for the introduction of the anti-adhesive layer into the security document after lamination of the optical security component on the support of the security document. This method can thus be implemented to any security document and at any time during the lifetime of the security document, for example, either at the beginning of its manufacture, or on a security document already in circulation.

The method of securement of a security document according to the invention comprises preferred steps that are performed in order to obtain a security document according to one or several preferred embodiments described above.

The security document to be secured is made by any suitable technique known to the man skilled in the art.

In a preferred embodiment, the anti-adhesive layer is applied according to a first predetermined pattern.

The anti-adhesive layer is applied to the optical security component by any suitable technique known by the man skilled in the art. According to a preferred embodiment, the anti-adhesive layer is applied on the optical security component by spraying, printing, or pad printing. In a preferred embodiment, the anti-adhesive layer is printed by ink jet printing or screen printing.

Advantageously, the application of the anti-adhesive layer on the security document by printing allows for high-resolution applications. Advantageously, printing of the anti-adhesive layer by screen printing enables a strong ink deposit. Advantageously, the printing of the anti-adhesive layer by ink jet printing allows for the application of the anti-adhesive layer according to a customisable pattern.

According to a preferred embodiment, the application of the anti-adhesive layer further comprises a step of crosslinking of the anti-adhesive layer. Advantageously, this step, which allows initiating the crosslinking of the anti-adhesive layer, allows preventing the subsequent dissolution of the anti-adhesive layer for malicious purposes.

According to a preferred embodiment, the application of the anti-adhesive layer further comprises a step of drying of the anti-adhesive layer.

According to a preferred embodiment, the crosslinking and/or drying are carried out under UVs.

In a preferred embodiment, the adhesive layer comprises heat reactivable adhesives requiring a post-crosslinking. In a preferred embodiment, the crosslinking of the adhesive layer is carried out together with the crosslinking of the anti-adhesive layer.

In a preferred embodiment, the anti-adhesive layer further comprises a mono- or poly-functional and crosslinkable solvent. In a preferred embodiment, the solvent is UV-crosslinkable, preferably by the same source of UVs than the crosslinkable resin of the anti-adhesive layer.

### BRIEF DESCRIPTION OF THE DRAWINGS

The invention will now be described with reference to the accompanying drawings in which the Figures are not to scale and the dimensions of certain elements have been enlarged for illustrative purposes, and in which

FIGS. 1a and 1b illustrate the principle of wetting; FIG. 1a illustrates the case of a high wettability and FIG. 1b illustrates the case of a low wettability,

FIG. 2 illustrates the measurement of the peeling force of the security document according to the invention,

FIG. 3 shows an exploded cross-sectional view of the security document according to an embodiment of the present invention,

FIG. 4 shows an exploded cross-sectional view of the security document according to another embodiment of the present invention,

FIG. 5 shows an exploded cross-sectional view of the security document according to another embodiment of the present invention,

FIG. 6a schematically shows the curvature of a security document of the prior art; FIG. 6b shows a top view of a security document according to an embodiment of the present invention; FIG. 6c shows a top view of a security document according to another embodiment of the present invention,

FIG. 7 schematically shows the method according to an embodiment of the present invention, and

FIG. 8 shows schematically the method according to another embodiment of the present invention.

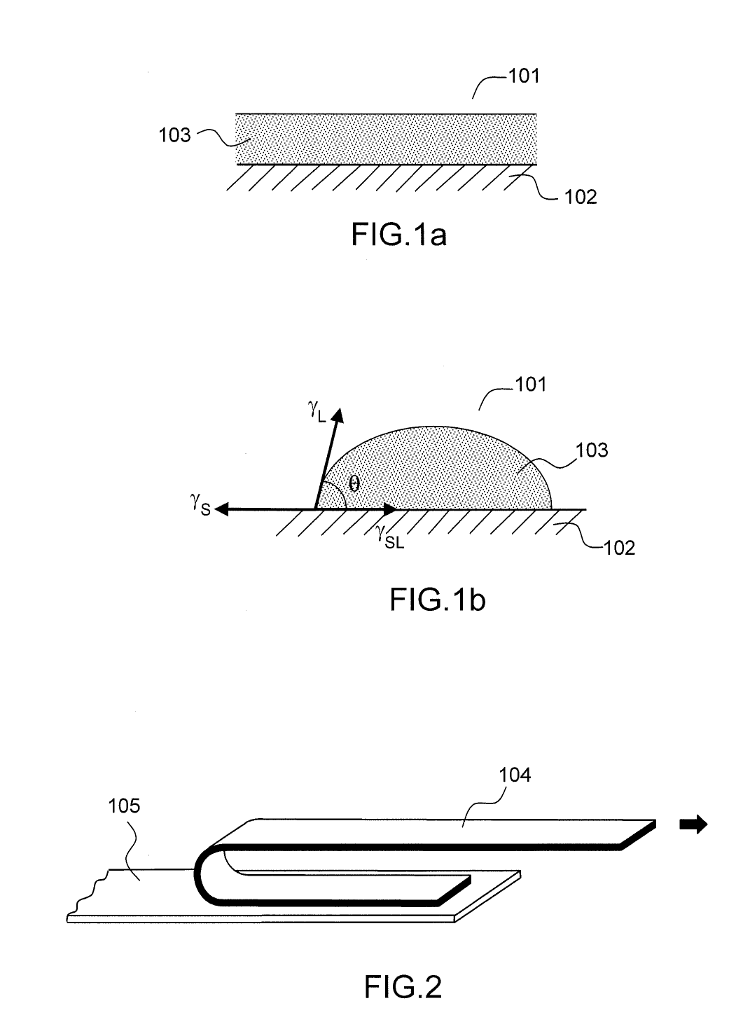

### DETAILED DESCRIPTION OF THE PREFERRED EMBODIMENTS

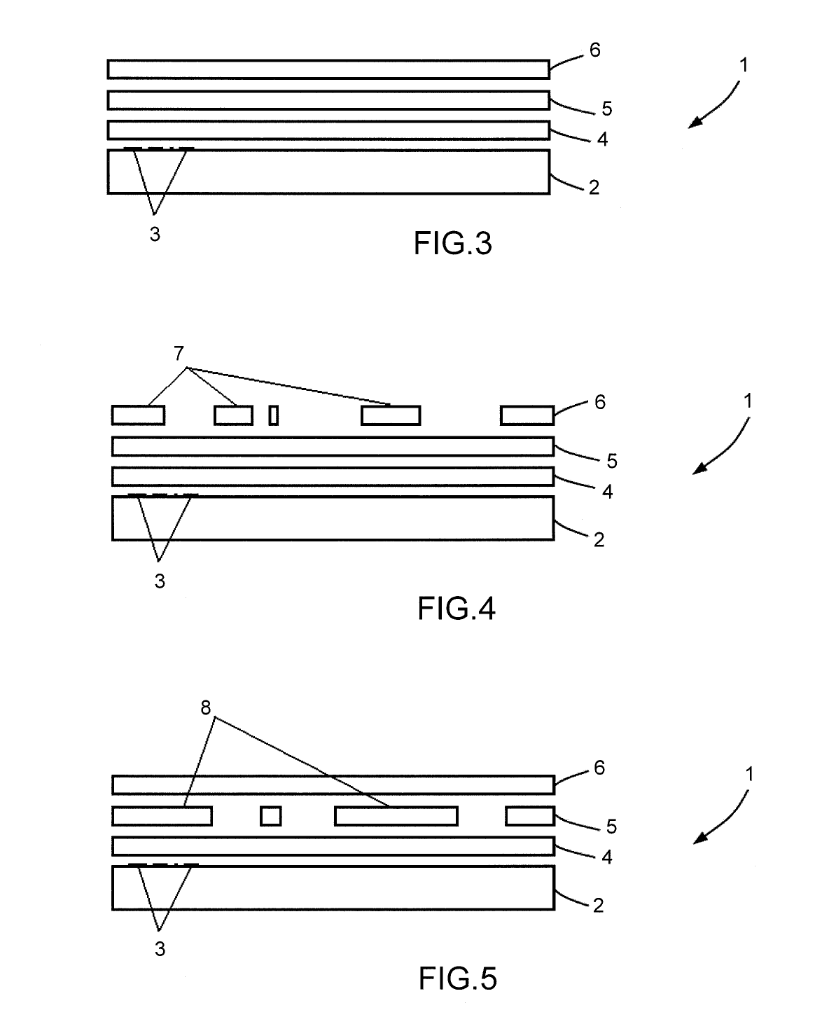

FIG. 3 shows the layers of a security document 1, for example, a passport page, in an exploded cross-sectional view for clarity, according to an embodiment of the present invention.

The security document 1 comprises a support 2 on which are inscribed personalization data 3, an adhesive layer 4, an optical security component 5 and an anti-adhesive layer 6.

FIG. 4 shows the security document 1 in a cross-sectional view according to another embodiment of the present invention.

The security document 1 comprises a support 2 on which are inscribed personalization data 3, an adhesive layer 4, an optical security component 5 and an anti-adhesive layer 6. The anti-adhesive layer 6 forms a first predetermined pattern 7.

FIG. 5 shows the security document 1 in a cross-sectional view according to yet another embodiment of the present invention.

The security document 1 comprises a support 2 on which are inscribed personalization data 3, an adhesive layer 4, an optical security component 5 and an anti-adhesive layer 6. The optical security component 5 forms a second predetermined pattern 8.

For example, the support 2 has a basis weight of 80 g/m² and is constituted of 50% of cotton and 50% of wood. The average thickness of the support 2 is comprised between 80 and 120 microns. The optical security component 5 comprises a ZnS layer embossed with a diffracting structure and has an average thickness of 4 microns. The adhesive layer 4 has an average thickness of 10 microns.

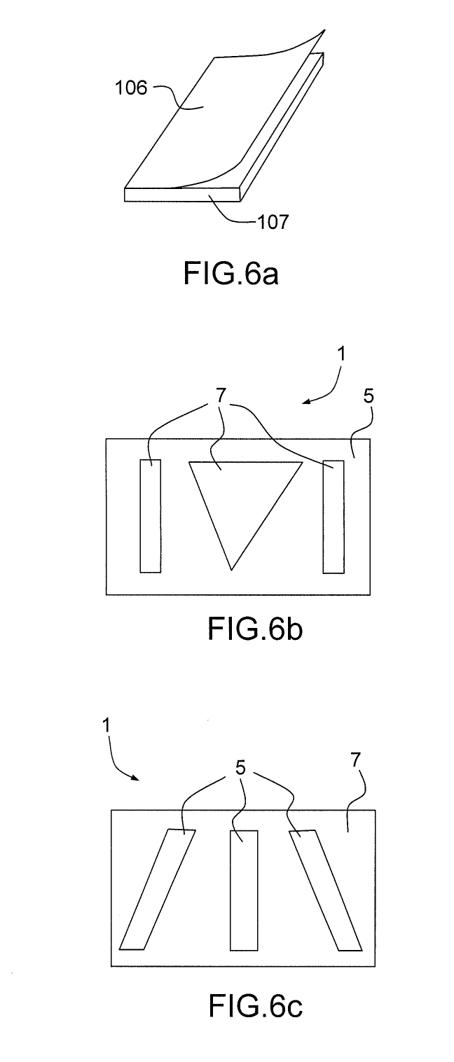

According to the prior art illustrated in FIG. 6a, the lamination of an optical security component on the support of a passport page 106 generally results in the curvature of the passport page 106 relative to the rest of the passport 107.

FIG. 6b shows a possible first predetermined pattern 7 allowing to counteract the curvature of the passport page after lamination of the optical security component on the passport page 1. In this example, the first predetermined pattern 7 is constituted of three filled elements of different shapes.

FIG. 6c shows another possible first predetermined pattern 7 allowing to counteract the curvature of the passport page 1 after lamination of the optical security component on the passport page 1. In this example, the first predetermined pattern 7 is constituted of a layer hollowed out in three areas.

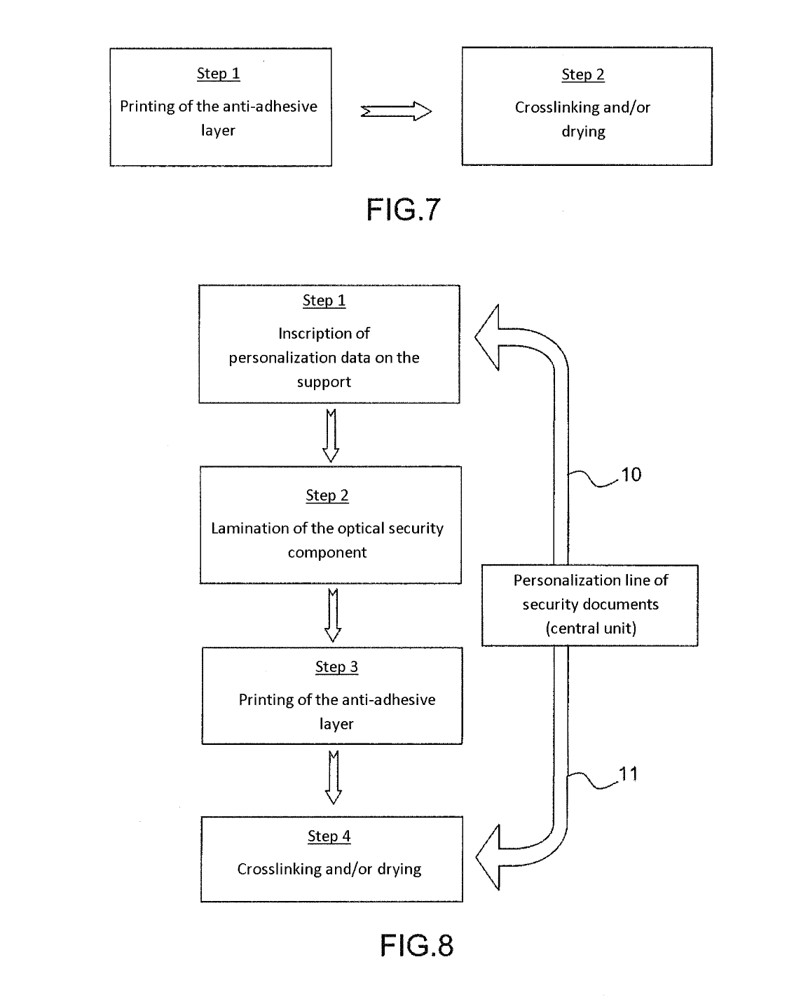

The method of securement of the security document 1 is described with reference to FIGS. 7 and 8.

In FIG. 7, according to an embodiment of the invention, the method of securement of the security document is implemented in a unit which complement an existing manufacturing line. The method first comprises the step 1 of printing the anti-adhesive layer on the optical security component. The printing can be done according to a first predetermined pattern. The method then comprises the step 2 of crosslinking and/or drying of the anti-adhesive layer.

For example, crosslinking is carried out using a UV lamp of a power of 130 W, such as a Mercury lamp, emitting UVAs, UVBs and UVCs. The crosslinking energy is for example about 500 mJ/cm² in UVBs.

In FIG. 8, according to another embodiment of the present invention, the method of securement of the security document is implemented in a security documents personalization centre. This personalization centre implements the steps 1 and 2 for the inscription of the personalization data on the support of the security document and the lamination of the optical security component. The method of securement of the present invention is inserted in this process and comprises the steps 3 and 4 of printing the anti-adhesive layer and crosslinking and/or drying the anti-adhesive layer. Arrows 10 and 11 indicate the information flow from the central unit to the inscription and printing stations (Steps 1 and 3).

### EXAMPLES

The peeling force of a security document according to the invention and of a security document according to the prior art without the anti-adhesive layer was measured.

The security document according to the prior art comprises a support having a basis weight of 80 g/m² and consists of 50% of cotton and 50% of wood, an optical security component and an anti-adhesive layer comprising a reactive silicone, a cationic photoinitiator agent and a UV crosslinkable resin.

The used measurement method is shown in FIG. 2. A strip of standard test adhesive material 104, i.e. a 3M adhesive tape referenced 3M-VHB, of 20 mm in width and laminated on a polyester sheet with a thickness of 36 microns, has been applied to samples 105 of 85 mm in width. The strip 104 was removed from the samples 105 at an angle of 90° and a speed of 1000 mm per minute (represented by the arrow in FIG. 2).

The average peeling force measured for a security document of the prior art without an anti-adhesive layer is 20 N and the adhesion of the standard test adhesive material on the security document is such that a cohesive rupture of the paper, which is defibered, is obtained.

The average peeling force measured for a security document according to the invention having an anti-adhesive layer is 0.5 mN.

In parallel, measures of the average total surface energy at the surface of the security document according to the invention and the security document according to the prior art have been performed.

The average total surface energy measured at the surface of the security document according to the invention is about 17.9 mN/m while the average total surface energy measured at the surface of the security document according to the prior art is 47.9 mN/m.

The invention thus described has the following advantage among others.

The security documents according to the invention allow preventing their falsification by peeling of the security laminate with an adhesive film. The methods of securement of the security documents according to the invention are implementable at any time during the life of the security documents as well as on an existing security documents personalization line without the need to modify the optical security component and/or the security document and therefore, independently of the supplier of said optical security component and/or said security document.

The invention has been described in particular embodiments illustrated by the different figures, which are not limitative. Further embodiments may be considered by the man skilled in the art such as, for example, the choice of materials, deposit techniques of the various layers, predetermined patterns.

1. A method of securement of a security document comprising:
providing a security document to be secured comprising a support on which are inscribed personalization data, an optical security component covering at least a portion of the personalization data and an adhesive layer positioned between the support and the optical security component; and
applying a transparent anti-adhesive layer on the optical security component.

2. The method according to claim 1, wherein the anti-adhesive layer is applied according to a first predetermined pattern.

3. The method according to claim 1, wherein the anti-adhesive layer is printed on the optical security component.

4. The method according to claim 3, wherein the printing is a screen printing or by ink jet.

5. The method according to claim 1, wherein applying the transparent anti-adhesive layer further comprises crosslinking of the anti-adhesive layer.

6. The method according to claim 5, wherein applying the transparent anti-adhesive layer further comprises drying of the anti-adhesive layer.

7. The method according to claim 6, wherein the crosslinking and/or drying of the anti-adhesive layer is carried out with UVs.

8. A security document, comprising:
a support on which are inscribed personalization data;
an optical security component covering at least a portion of the personalization data;
an adhesive layer positioned between the support and the optical security component; and
a transparent anti-adhesive layer, positioned on the optical security component and forming a first predetermined pattern.

9. The security document according to claim 8, wherein the anti-adhesive layer has an average total surface energy of less than 25 mN/m.

10. The security document according to claim 9, wherein the anti-adhesive layer has an average peeling force of less than 1 N.
